(19) United States
(12) Patent Application Publication
(10) Pub. No.: US 2017/0225148 A1
(43) Pub. Date: Aug. 10, 2017

(54) FULLY MOISTURE-TIGHT MULTILAYER MATERIAL, CAPABLE OF ABSORBING, RETAINING AND NOT RELEASING ABSORBED FREE WATER, FOR PACKAGING FOOD, DIETARY AND COSMETIC PRODUCTS, MEDICAL DEVICES AND MEDICINAL PRODUCTS

(71) Applicant: PROBIOTICAL S.P.A., 28100 NOVARA (NO) (IT)

(72) Inventor: GIOVANNI MOGNA, NOVARA (IT)

(73) Assignee: PROBIOTICAL S.P.A., 28100 NOVARA (NO) (IT)

(21) Appl. No.: 15/514,873

(22) PCT Filed: Oct. 2, 2015
(86) PCT No.: PCT/IB2015/057548

§ 371 Date: Mar. 28, 2017

(30) Foreign Application Priority Data
Oct. 2, 2014 (IT) MI2014A001722

(51) Int. Cl. B01J 20/28; B32B 15/04; B32B 15/085; B32B 15/20; B01J 20/02; B32B 23/20; B32B 27/32; B01J 20/24; B01J 20/26; B32B 7/12; B32B 23/04

(52) U.S. Cl. CPC B01J 20/2805; B32B 7/12; B32B 15/043; B32B 15/085; B32B 15/20; B32B 23/042; B32B 23/20; B32B 27/32; B01J 20/24; B01J 20/261; B01J 20/02; B01J 20/262; B32B 2255/06; B32B 2255/10; B32B 2255/26; B32B 2307/726; B32B 2307/718; B32B 2439/70; B32B 2439/80; B32B 2307/7246; B32B 2307/7244; B32B 2255/20

(57) ABSTRACT

The present invention relates to a fully moisture-tight multilayer material, which is also able to absorb, retain and not release the absorbed moisture or free water into the formulations containing pharmacological active substances and/or instable components with biological activity and/or effervescent and/or easily perishable formulations; said material being useful for preparing bags, envelopes and sachets for packaging food, dietary and cosmetic products, medical devices and medicinal products. The multilayer material of the present invention is a multilayer material that is useful for preparing containers in the form of bags, envelopes, sachets and sticks coming into direct contact with the formulations of the food, dietary and cosmetic products as well as of the medical devices and medicinal products in the form of e.g. lactic bacteria and/or bifidobacteria in powders or granules, either dried or freeze-dried.

The present invention relates to a fully moisture-tight multilayer material, which is also able to absorb, retain and not release the absorbed moisture or free water into the formulations containing pharmacological active substances and/or instable components with biological activity and/or effervescent and/or easily perishable formulations; said material being useful for preparing bags, envelopes, sachets and sticks for packaging food, dietary and cosmetic products, medical devices and medicinal products.

The multilayer material of the present invention is a multilayer material that is useful for preparing containers in the form of bags, envelopes, sachets and sticks coming into direct contact with the formulations of the food, dietary and cosmetic products as well as of the medical devices and medicinal products in the form of e.g. lactic bacteria and/or bifidobacteria in powders or granules, either dried or freeze-dried.

It is known about the importance of choosing a suitable packaging material when handling formulations containing pharmacological active substances and/or instable components with biological activity and/or effervescent and/or easily perishable formulations, such as e.g. in the case of lactic bacteria or bifidobacteria in powder or granules, either dried or freeze-dried. This need arises from the fact that a packaging material should ensure an absolute tightness to moisture, water vapor and oxygen at the same time, further ensuring a suitable stability and shelf life, which is useful for marketing both raw materials and finished foods such as e.g. food, dietary and cosmetic products, medical devices and medicinal products containing lactic bacteria and/or bifidobacteria in powder or granules, either dried or freeze-dried.

Primary packaging or multilayer packaging material means the material getting into direct contact with the raw materials or with the formulations of the medicinal products, medical devices, food, dietary and cosmetic products.

In the case of formulations containing pharmacological active substances and/or instable components with biological activity and/or effervescent and/or easily perishable formulations, such as e.g. lactic bacteria and bifidobacteria having a value of free water (cytoplasmic water) playing an essential role for their viability, stability and for the shelf life of such formulations, it is necessary to have a multilayer packaging material that is able to build a fully tight barrier between the formulations and the outer environment (moisture, water vapor, light and oxygen).

At present, the multilayer materials that are available on the market do not seem to be able to ensure a suitable and lasting barrier effect as well as a sufficient stability as to avoid the perishing and loss of viability of the cells of the lactic bacteria and/or of the bifidobacteria.

Agents coming from the outer environment (moisture, water vapor, light and oxygen) can modify some chemical-physical parameters of the formulations causing instability and loss of effectiveness of the active components contained therein. Said agents have proved particularly significant in accelerating oxidative, hydrolytic, photochemical and putrefactive reaction kinetics. If the active substances consist of or comprise microorganisms, said external agents (moisture, water vapor, light and oxygen) can highly affect the microbial metabolism with subsequent formation of toxic catabolites leading to cell death.

In the field of probiotics, i.e. microorganisms that able to give consumers beneficial effects on their health if eaten in suitable amounts and for suitable times, the effectiveness during the shelf life is compromised if the microbial metabolism is not sufficiently slackened or reduced. A sufficiently slackened or reduced metabolism can be obtained not only ensuring, when manufacturing the probiotic product, an extremely low moisture and free water level but avoiding, during product shelf life, moisture and oxygen increase. Therefore, during product shelf life, it is necessary to contrast the ingress of ambient moisture and/or oxygen from the outside to the inside of said product.

Moreover, in the formulations based on probiotic microorganisms bacteria are mixed with technological additives or formulation excipients containing in their turn a certain level of moisture or free water. In these cases the bacteria are in an even more unfavorable and instable environment since the moisture or free water present is too high and contributes to accelerate the degradation thereof over time.

It would be useful to have a multilayer packaging material that is able to absorb in a continuous and systematic manner over time the moisture or free water present in the formulations containing lactic bacteria and/or bifidobacteria in the form of powder or granules, either dried or freeze-dried present therein and, once free water is collected, it should be stored and no longer released.

Therefore, in this type of products based on probiotic microorganisms, it would be useful to be able to reduce the content of moisture or free water present in the dried or freeze-dried bacteria and the content of moisture or free water present in the technological additives or formulation excipients used.

It is known on the market about the presence of some multilayer packaging materials that are commonly used for preparing bags, envelopes, sachets and sticks containing the raw materials or the formulations of the food, dietary and cosmetic products as well as of the medical devices and medicinal products in the form of e.g. lactic bacteria and/or bifidobacteria in powders or granules, either dried or freeze-dried.

Said known multilayer packaging materials consist of two aluminum layers coupled together by means of techniques and equipment that are known to a skilled technician, thus obtaining an aluminum multilayer. Said aluminum multilayer has a first and a second outer face. Said aluminum multilayer is then coupled with a polyester PET layer on one side and with a polyethylene PE and/or polyvinyl chloride PVC layer on the other, thus obtaining a multilayer material e.g. of type [PET/Al—Al/PE]. These types of multilayer materials, though having acceptable mechanical and barrier properties, are not without drawbacks limiting the use thereof in particular when it is necessary to ensure a full moisture barrier and at the same time a longer stability and shelf life of 24/36 months (both in mild and tropical climates) after packaging for marketing purposes both of the raw materials such as e.g. lactic bacteria and/or bifidobacteria in the form of powder or granules, either dried or freeze-dried, and of the finished products such as e.g. food, dietary and cosmetic products, as well as medical devices and medicinal products containing lactic bacteria and/or bifidobacteria in powder or granules, with dried or freeze-dried.

Therefore, there is still the need to have a multilayer packaging material that is able to ensure a fully moisture-tight and lasting barrier effect as well as a sufficient stability so as to avoid the subsequent perishing of the active substances or of the microorganisms contained therein.

It would be desirable to have a multilayer packaging material that is fully tight to water, moisture, water vapor and oxygen ensuring a shelf life of at least 24/36 months (both in mild and tropical climates) from packaging for raw materials and food, dietary and cosmetic products, medical devices and medicinal products, containing lactic bacteria and/or bifidobacteria in powder or granules, either dried or freeze-dried.

After a long and deep activity of research and development, the Applicant has met the aforesaid needs by providing a new multilayer material for packaging both raw materials such as e.g. lactic bacteria and/or bifidobacteria in powder or granules, either dried or freeze-dried, and finished products such as e.g. food, dietary and cosmetic products, medical devices and medicinal products.

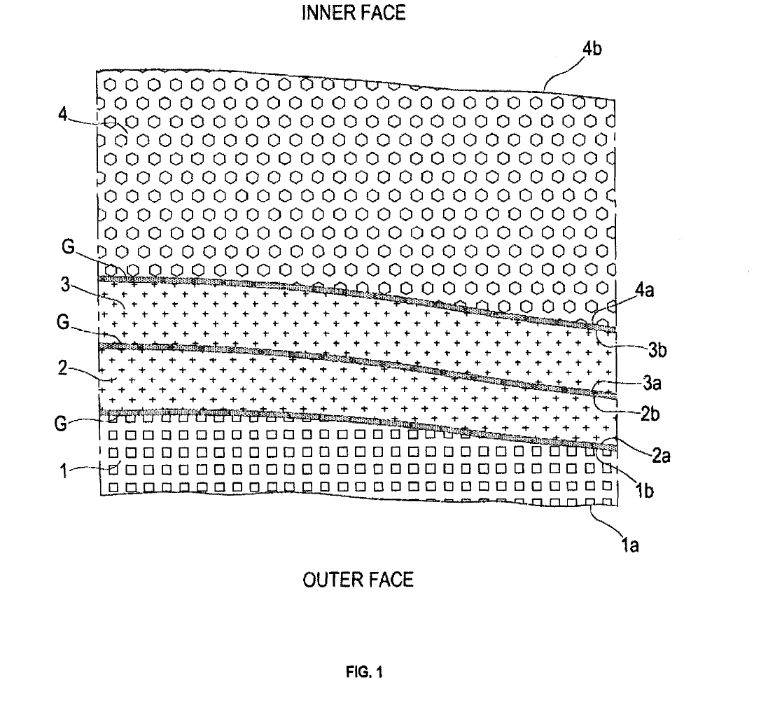

An object of the present invention is a multilayer packaging material, as disclosed by way of non-limiting example in FIG. 1, comprising:
a first outer layer of a material comprising or alternatively consisting of cellulose acetate AC 1 having a first outer face 1a and a second outer face 1b;
at least a first layer of a material comprising or alternatively consisting of aluminum Al 2 and a second layer of a material comprising or alternatively consisting of aluminum Al 3, coupled with one another so as to obtain an aluminum multilayer 2-3 having a first outer face 2a and a second outer face 3b;
a second outer layer of a material comprising or alternatively consisting of polyethylene PE 4 having a first outer face 4a and a second outer face 4b, said second outer face 4b being the one in direct contact with the raw materials or with the formulations containing pharmacological active substances and/or instable and/or easily perishable components with biological activity.

For simplicity's sake, said multilayer material (FIG. 1) can be schematized as follows [AC/Al—Al/PE], wherein:
the symbol “/” designates a coupling made according to the techniques and equipment known to a skilled technician by using a two-component, solvent-based polyurethane adhesive, referred to as G in FIG. 1;
AC designates a layer of material comprising or alternatively consisting of cellulose acetate;
Al—Al designates an aluminum multilayer (two layers);
PE designates a layer of material comprising or alternatively consisting of polyethylene.

The Applicant has tested said multilayer material [AC/Al—Al/PE]. The data shown in Table 10 demonstrate that the multilayer material according to the present invention is able to ensure a full moisture tightness from outside to inside, indeed it is able to maintain for up to 24 months a value of free water Aw below 0.029, i.e. like the initial value at zero time, whereas the reference multilayer material increases free water from 0.029 to 0.050 after 24 months.

The Applicant has found that a full tightness to moisture, free water Aw, oxygen and light can be obtained only by coupling a layer of material comprising or alternatively consisting of cellulose acetate (AC) with an aluminum multilayer having at least two layers of aluminum (Al—Al);

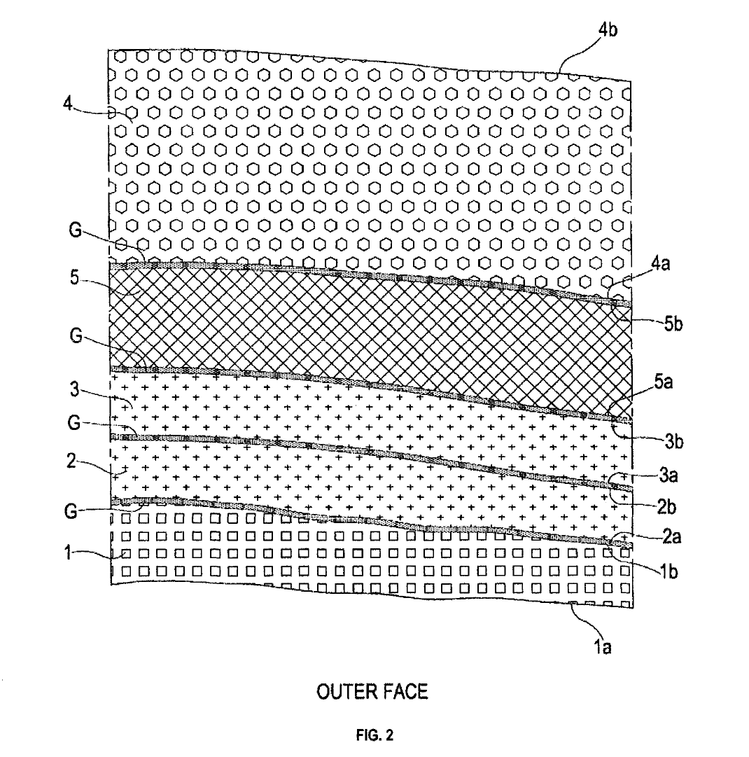

Another object of the present invention is a multilayer packaging material, as disclosed by way of non-limiting example in FIG. 2, comprising:
a first outer layer of a material comprising or alternatively consisting of cellulose acetate (AC) 1 having a first outer face 1a and a second outer face 1b;
at least a first layer of a material comprising or alternatively consisting of aluminum Al 2 and a second layer of a material comprising or alternatively consisting of aluminum Al 3, coupled with one another so as to obtain an aluminum multilayer 2-3 having a first outer face 2a and a second outer face 3b;
a layer of a material comprising or alternatively consisting of a hygroscopic material, in particular polyamide PA 5 having a first outer face 5a and a second outer face 5b;
a second outer layer of a material comprising or alternatively consisting of polyethylene PE 4 having a first outer face 4a and a second outer face 4b, said second outer face 4b being the one in direct contact with the raw materials or with the formulations containing pharmacological active substances and/or instable and/or easily perishable components with biological activity.

For simplicity's sake, said multilayer material (FIG. 2) can be schematized as follows [AC/Al—Al/PA/PE], wherein:
the symbol “/” designates a coupling made according to the techniques and equipment known to a skilled technician by using a two-component, solvent-based polyurethane adhesive, referred to with G in FIG. 2;
AC designates a layer of material comprising or alternatively consisting of cellulose acetate;
Al—Al designates an aluminum multilayer (two layers);
PA designates a layer of hygroscopic material comprising or alternatively consisting of polyamide or nylon 6 (Opha);
PE designates a layer of material comprising or alternatively consisting of polyethylene.

The layer of material 5 shown by way of example in FIG. 2 should be made of a hygroscopic material, preferably it is a layer of material comprising or alternatively consisting of polyamide PA or nylon 6. The Applicant has tested said multilayer material [AC/Al—Al/PA/PE]. The experimental data show that the hygroscopic material according to the present invention, of the type in FIG. 2, is able to combine a full moisture tightness from outside to inside (extremely low free water Aw values, see Table 10) with a high stability of the product contained therein, which is maintained over time thanks to the capacity of the multilayer material to absorb (slowly “stripping” moisture and free water as a function of time) moisture and free water present in the raw materials or in the formulations containing pharmacological active substances and/or instable and/or easily perishable components with biological activity, such as e.g, in the case of lactic bacterial or bifidobacteria in powder or granules, either dried or freeze-dried.

In practice, the Applicant has observed that the introduction of a layer of hygroscopic material with variable thickness comprising or alternatively consisting of a polyamide PA, e.g. nylon 6 (Opa) (layer 5) is able to absorb (strip) over time the cytoplasmic free water remaining in the freeze-dried bacterial cells obtained also as a result of forced freeze-drying processes which in any case reach a free water Aw content of about 0.05. It has been observed that the most effective stripping action should be continued in a highly slow and gradual manner in the f24/36 months after the packaging, thus ensuring a stability and a shelf life that would otherwise not be obtainable with other tested multilayer materials.

The moisture stripped from inside the formulation by the layer of hygroscopic material 5 (FIG. 2) with variable thickness is no longer released by the multilayer material because the hygroscopic material 5 irreversibly binds the absorbed water or moisture (irreversible stripping). The absorbed water or moisture is isolated inside the multilayer material and is no longer released since it cannot get over the aluminum multilayer 2-3 coupled with the layer of acetate cellulose material 1 (FIG. 2) by means of an irreversible and unidirectional stripping, i.e. from inside to outside.

The Applicant has found out that the stripped free water or moisture is proportional over time to the thickness of the layer of hygroscopic material. The thickness of the hygroscopic material of 5 to 1000 microns, preferably of 10 to 50 microns, can be obtained by one or more layers of hygroscopic material, such as e.g. one or more layers of a material comprising or alternatively consisting of polyamide PA o nylon, e.g. nylon 6 (Opa).

The Applicant has tested the stability of a multilayer packaging material made of a material such as the one designated MM2 of the type [PET/Al—Al/PE] (see below) with a multilayer packaging material of the type MM4 of the type [AC/Al—Al/PA/PE] (FIG. 2) analyzing t_{1/2} at 25° C. and 75% of humidity. The material MM2 has a t_{1/2} of about 350 days, whereas the material MM4 has a t_{1/2} of about 1500 days, the charge (CFUs/g) of bacterial lyophilisate and operating conditions being the same.

The Applicant has found that, the final thickness being the same, an aluminum multilayer having at least two single aluminum layers, e.g. each with a thickness of 9 μm, coupled together ensures a much lower permeability than a single aluminum layer having the same final thickness, e.g. of 18 μm, as the double layer (aluminum multilayer), above all as far as moisture, water vapor and oxygen are concerned.

The material with two aluminum layers (aluminum multilayer) has several advantages with respect to the same aluminum single layer material, the final thickness being the same (Table 9).

The multilayer material of the present invention comprises at least two sheets/layers of aluminum, preferably laminated aluminum, coupled together by means of gluing with suitable adhesive compounds that can be spread onto the outer surface of the aluminum layer and heated using the equipment and techniques known to a skilled technician.

Moreover, the Applicant has surprisingly found that the interposition of at least one layer of a hygroscopic material such as polyamide PA 5, coupled on one side with an outer face 3b of the aluminum multilayer 2-3 and on the other side with a first outer face 4a of a layer of polyethylene PE material 4, enables to absorb and store the moisture or free water present in the formulation, thus achieving a double effect: on the one side, there is a barrier effect, from outside to inside the formulation, exerted by the double layer of aluminum 2-3, and on the other an effect of irreversible absorption of the moisture or free water present in the formulation. In practice, the moisture or free water present in the raw materials or in the formulations containing pharmacological active substances and/or instable and/or easily perishable components with biological activity, such as e.g. for microorganisms or bacteria, is absorbed over time by the multilayer packaging material, retained and no longer released, thus ensuring a fully tight system.

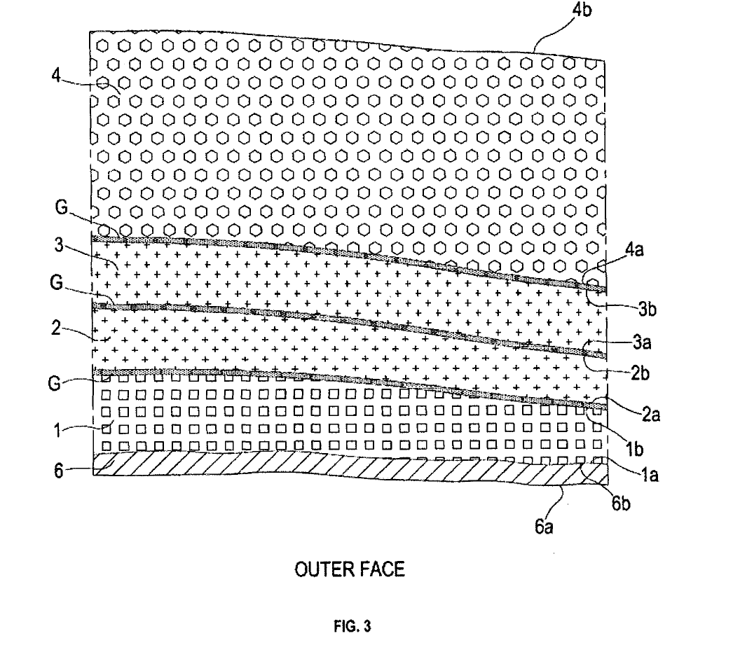

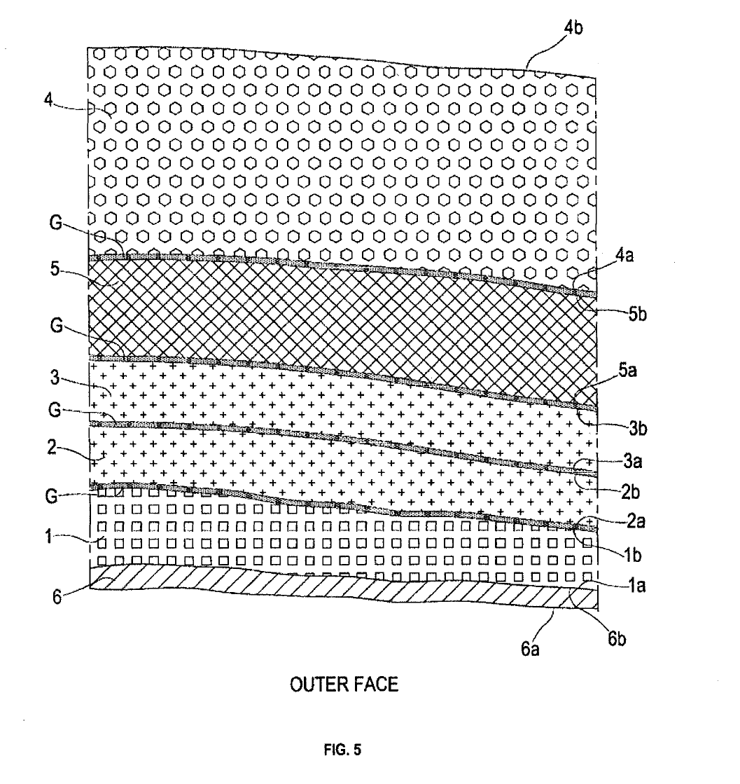

In a further embodiment, the Applicant after further experimental tests has found it useful and advantageous to use a graphene layer or coating, which is coupled or arranged onto said first one outer layer of a material comprising or alternatively consisting of cellulose acetate AC 1. Examples of said further embodiment are shown in FIGS. 3 and 5.

An object of the present invention is a multilayer packaging material, as disclosed by way of non-limiting example in FIG. 3, comprising:
a layer or coating of a material comprising or alternatively consisting of graphene GFN 6 having a first outer face 6a and a second outer face 6b;
a first outer layer of a material comprising or alternatively consisting of cellulose acetate AC 1 having a first outer face 1a and a second outer face 1b;
at least a first layer of a material comprising or alternatively consisting of aluminum Al 2 and a second layer of a material comprising or alternatively consisting of aluminum Al 3, coupled with one another so as to obtain an aluminum multilayer 2-3 having a first outer face 2a and a second outer face 3b;
a second outer layer of a material comprising or alternatively consisting of polyethylene PE 4 having a first outer face 4a and a second outer face 4b, said second outer face 4b being the one in direct contact with the raw materials or with the formulations containing pharmacological active substances and/or instable and/or easily perishable components with biological activity.

For simplicity's sake, said multilayer material (FIG. 3) can be schematized as follows [GFN/AC/Al—Al/PE], wherein:
the symbol T designates a coupling made according to the techniques and equipment known to a skilled technician by using a two-component, solvent-based polyurethane adhesive, referred to with G in FIG. 3;
GFN designates a layer or coating of material comprising or alternatively consisting of graphene;
AC designates a layer of material comprising or alternatively consisting of cellulose acetate;
Al—Al designates an aluminum multilayer (two layers);
PE designates a layer of material comprising or alternatively consisting of polyethylene.

Another object of the present invention is a multilayer packaging material, as disclosed by way of non-limiting example in FIG. 5, comprising:
a layer or coating of a material comprising or alternatively consisting of graphene GFN 6 having a first outer face 6a and a second outer face 6b;
a first outer layer of a material comprising or alternatively consisting of cellulose acetate 1 having a first outer face 1a and a second outer face 1b;
at least a first layer of a material comprising or alternatively consisting of aluminum Al 2 and a second layer of a material comprising or alternatively consisting of aluminum Al 3, coupled with one another so as to obtain an aluminum multilayer 2-3 having a first outer face 2a and a second outer face 3b;
a layer of a material comprising or alternatively consisting of a hygroscopic material, in particular polyamide PA 5 having a first outer face 5a and a second outer face 5b;
a second outer layer of a material comprising or alternatively consisting of polyethylene PE 4 having a first outer face 4a and a second outer face 4b, said second outer face 4b being the one in direct contact with the raw materials or with the formulations containing pharmacological active substances and/or instable and/or easily perishable components with biological activity.

For simplicity's sake, said multilayer material (FIG. 5) can be schematized as follows [GFN/AC/Al—Al/PA/PE], wherein:
the symbol “/” designates a coupling made according to the techniques and equipment known to a skilled technician by using a two-component, solvent-based polyurethane adhesive, referred to with G in FIG. 5;
GFN designates a layer or coating of material comprising or alternatively consisting of graphene;
AC designates a layer of material comprising or alternatively consisting of cellulose acetate;
Al—Al designates an aluminum multilayer (two layers);
PA designates a layer of hygroscopic material comprising or alternatively consisting of polyamide or nylon 6 (Opha);
PE designates a layer of material comprising or alternatively consisting of polyethylene.

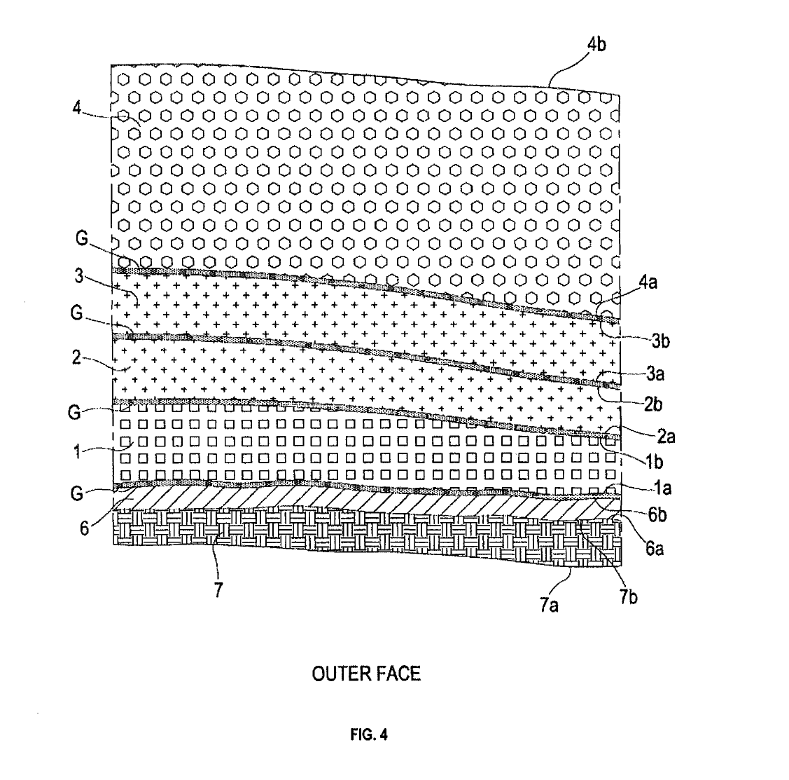

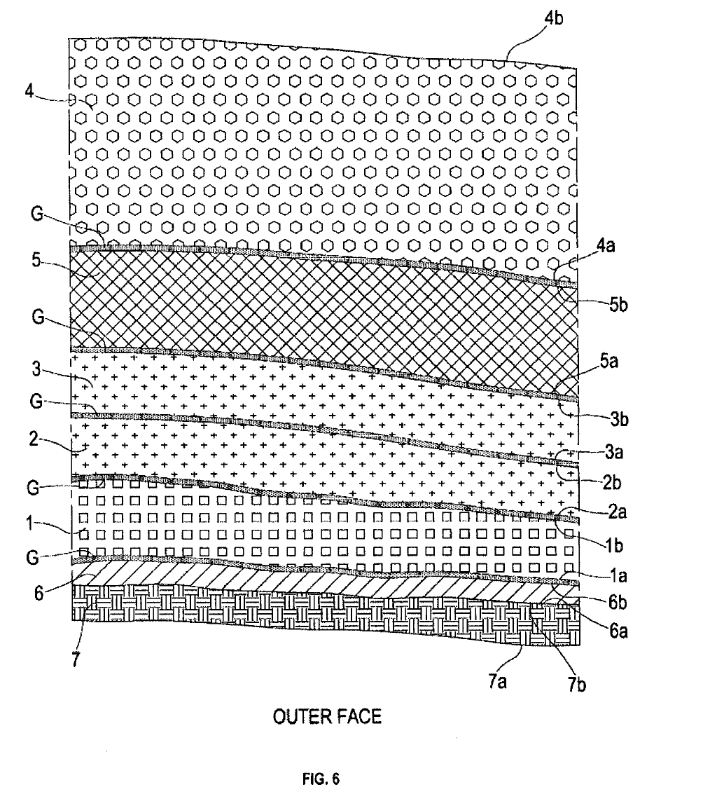

In a further embodiment, the Applicant after further experimental tests has found it useful and advantageous to use a layer of a material comprising or alternatively consisting of a polyester PET (polyethylene terephthalate), which is coupled or arranged onto said graphene coating, the latter being in its turn coupled or arranged onto said first one outer layer of a material comprising or alternatively consisting of cellulose acetate AC 1. Examples of said further embodiment are shown in FIGS. 4 and 6,

An object of the present invention is a multilayer packaging material, as disclosed by way of non-limiting example in FIG. 4, comprising:
a layer of a material comprising or alternatively consisting of a polyester PET (polyethylene terephthalate) PET 7 having a first outer face 7a and a second outer face 7b;
a layer or coating of a material comprising or alternatively consisting of graphene GFN 6 having a first outer face 6a and a second outer face 6b;
a first outer layer of a material comprising or alternatively consisting of cellulose acetate AC 1 having a first outer face 1a and a second outer face 1b;
at least a first layer of a material comprising or alternatively consisting of aluminum Al 2 and a second layer of a material comprising or alternatively consisting of aluminum Al 3, coupled with one another so as to obtain an aluminum multilayer 2-3 having a first outer face 2a and a second outer face 3b;
a second outer layer of a material comprising or alternatively consisting of polyethylene PE 4 having a first outer face 4a and a second outer face 4b, said second outer face 4b being the one in direct contact with the raw materials or with the formulations containing pharmacological active substances and/or instable and/or easily perishable components with biological activity.

For simplicity's sake, said multilayer material (FIG. 4) can be schematized as follows [PET/GFN/AC/AL-AL/PE], wherein:
the symbol “/” designates a coupling made according to the techniques and equipment known to a skilled technician by using a two-component, solvent-based polyurethane adhesive, referred to with G in FIG. 4;
PET designates a layer of a material comprising or alternatively consisting of a polyester PET (polyethylene terephthalate);
GFN designates a layer or coating of material comprising or alternatively consisting of graphene;
AC designates a layer of material comprising or alternatively consisting of cellulose acetate;
Al—Al designates an aluminum multilayer (two layers);
PE designates a layer of material comprising or alternatively consisting of polyethylene.

Another object of the present invention is a multilayer packaging material, as disclosed by way of non-limiting example in FIG. 6, comprising:
a layer of a material comprising or alternatively consisting of a polyester PET (polyethylene terephthalate) PET 7 having a first outer face 7a and a second outer face 7b;
a layer or coating of a material comprising or alternatively consisting of graphene GFN 6 having a first outer face 6a and a second outer face 6b;
a first outer layer of a material comprising or alternatively consisting of cellulose acetate 1 having a first outer face 1a and a second outer face 1b;
at least a first layer of a material comprising or alternatively consisting of aluminum Al 2 and a second layer of a material comprising or alternatively consisting of aluminum Al 3, coupled with one another so as to obtain an aluminum multilayer 2-3 having a first outer face 2a and a second outer face 3b;
a layer of a material comprising or alternatively consisting of a hygroscopic material, in particular polyamide PA 5 having a first outer face 5a and a second outer face 5b;
a second outer layer of a material comprising or alternatively consisting of polyethylene PE 4 having a first outer face 4a and a second outer face 4b, said second outer face 4b being the one in direct contact with the raw materials or with the formulations containing pharmacological active substances and/or instable and/or easily perishable components with biological activity.

For simplicity's sake, said multilayer material (FIG. 6) can be schematized as follows [PET/GFN/AC/Al—Al/PA/PE], wherein:
the symbol “/” designates a coupling made according to the techniques and equipment known to a skilled technician by using a two-component, solvent-based polyurethane adhesive, referred to with G in FIG. 6;
PET designates a layer of a material comprising or alternatively consisting of a polyester PET (polyethylene terephthalate);
GFN designates a layer or coating of material comprising or alternatively consisting of graphene;
AC designates a layer of material comprising or alternatively consisting of cellulose acetate;
Al—Al designates an aluminum multilayer (two layers);
PA designates a layer of hygroscopic material comprising or alternatively consisting of polyamide or nylon 6 (Opha);
PE designates a layer of material comprising or alternatively consisting of polyethylene.

In the context of the present invention, said material comprising or alternatively consisting of cellulose acetate AC1 can also comprise in its turn a cellulose diacetate or a cellophane material.

Another object of the present invention is the use of said multilayer material A or B, shown by way of non-limiting example in FIGS. 1 and 2, for preparing containers in the form of bags, envelopes or sachets having the characteristics listed in the appended claims.

Other preferred embodiments of the present invention are described in the following detailed description and these embodiments will be claimed in the appended dependent claims.

Preferred embodiments of the present invention are represented by the multilayer materials MM, such as: MM3 (FIG. 1), MM4 (FIG. 2), MM5 (FIG. 3), MM6 (FIG. 4), MM7 (FIG. 5) and MM8 (FIG. 6).

In a preferred embodiment, the multilayer material MM of the present invention comprises a number of aluminum sheets/layers of 2 to 4. The thickness of every single aluminum sheet/layer is of 5 to 40 μm. In a preferred embodiment, the thickness of every single aluminum sheet/layer is of 8 to 20 μm. In another preferred embodiment, the thickness of every single aluminum sheet/layer is of 8 to 20 μm, preferably of 9 or 18 μm. A skilled technician is aware that the above values concerning thicknesses are subject to variations due to a tolerance of ±2% to ±8%, usually of ±4% to ±6%.

The weight of the aluminum sheets/layers as used depends on the sheet thickness. For instance, an aluminum sheet/layer with a thickness of 20 μm has a weight of 45 to 60 g/m2, preferably of 50 to 55 g/m2, e.g. 54 g/m2. For instance, an aluminum sheet/layer with a thickness of 9 μm has a weight of 20 to 30 g/m2, preferably of 22 to 26 g/m2, e.g. 24.30 g/m2. A skilled technician is aware that the above values concerning the weight of the single sheets/layers are subject to variations due to a tolerance that can be of ±2% to ±8%, usually of ±4% to ±6%.

In a preferred embodiment, a multilayer material of the present invention MM is made up of a first and a second sheet each having a thickness of 5 to 20 μm, e.g. 9 μm. For instance, two sheets with a thickness of 9 μm (microns) each can be used, or a sheet or layer with a thickness of 9 μm and another one with a thickness of 12 μm or 18 μm or 24 μm. The single sheets are coupled with equipment and techniques known to a skilled technician.

The permeability of polymeric materials is known for many materials. The oxygen transmission rate OTR (cm³ m⁻²d⁻¹atm⁻¹ at 23° C., 50% RH) and the water vapor transmission rate WVTR (gm-2d⁻¹ at 23° C., 75% RH) of composite films containing 12 μm of PET, are known. A single sheet/layer of laminated aluminum has a water vapor permeability value of 0.1 g/m²/day and an oxygen permeability value below 0.1 g/m²/day.

One embodiment of the multilayer material of the present invention is shown in FIG. 1 and comprises: at least a first layer of aluminum 2 and a second layer of aluminum 3, coupled with one another so as to obtain an aluminum multilayer 2-3 having a first outer face 2a and a second outer face 3b. Said aluminum multilayer 2-3 is obtained by coupling said first layer 2, having a first outer face 2a and a second outer face 2b, with said second layer 3, having a first outer face 3a and a second outer face 3b. The coupling is made with the techniques and equipment known to a skilled technician using a solvent-based, two-component polyurethane adhesive material, e.g. such as NOVACOTE NC-250-A with catalyst CA-350—COIM DEUTSCHLAND GmbH. The solvents that can be used are ethyl acetate of urethane grade or acetone (water content below 0.1%). The layers are assembled with known lamination methods by coupling together the single layers using a two-component polyurethane adhesive material as mentioned above.

Said aluminum multilayer (2-3) having a first outer face (2a) and a second outer face (3b) is coupled with at least one layer of a polyethylene material 4 having a first outer face 4a and a second outer face 4b; said second outer face 3b being coupled with said first outer face 4a. The coupling is made with the techniques and equipment known to a skilled technician using a solvent-based, two-component polyurethane adhesive material, e.g. such as NOVACOTE NC-250-A with catalyst CA-350—COIM DEUTSCHLAND GmbH. The solvents that can be used are ethyl acetate of urethane grade or acetone (water content below 0.1%). The layers are assembled with known lamination methods by coupling together the single layers using a two-component polyurethane adhesive material as mentioned above or having similar characteristics.

Said first outer layer 2a is coupled with a layer of cellulose acetate material 1 having a first outer face 1a and a second outer face 1b. The coupling occurs between said second outer face 1b and said first outer face 2a. The coupling is made with the techniques and equipment known to a skilled technician using an adhesive material as mentioned above. The layers are assembled with known lamination methods by coupling together the single layers using a two-component polyurethane adhesive material as mentioned above or having similar characteristics.

The second outer face 4b is the one in contact with the raw materials or with the formulations containing pharmacological active substances and/or instable components with biological activity and/or effervescent and/or easily perishable formulations such as e.g. microorganisms or bacteria in the form of dried powder or lyophilisates.

The Applicant has found that the introduction of at least one layer of hygroscopic material such as polyamide 5 between said aluminum multilayer 2-3 and said layer of polyethylene material 4 has a positive function of moisture or free water absorption towards the inside of the layer of polyethylene material 4 in contact with said at least one polyamide layer 5 (irreversible and unidirectional stripping action).

The absorbed moisture or free water is retained and not released over time so as to ensure a suitable and lasting barrier effect.

Therefore, a second embodiment of the multilayer material of the present invention is shown in FIG. 2 and comprises the multilayer material described above and shown in FIG. 1, in which a layer of hygroscopic material such as polyamide 5 is coupled at its end 5b with the face 4a and at its end 5a with the face 3b. The coupling is made with the techniques and equipment known to a skilled technician using an adhesive material as described above. The layers are assembled with known lamination methods by coupling together the single layers using a two-component polyurethane adhesive material as mentioned above or having similar characteristics.

A third embodiment of the multilayer material of the present invention is shown in FIG. 3 and comprises the multilayer material described above and shown in FIG. 1, in which a layer or coating of a material comprising or alternatively consisting of graphene GFN 6 (having a first outer face 6a and a second outer face 6b) is coupled or arranged with its end 6b onto said first outer face 1a of said material comprising or alternatively consisting of cellulose acetate AC 1. Said layer or coating of said material comprising or alternatively consisting of graphene GFN 6 is applied by means of a flexographic or gravure printing method by lamination, according to the equipment and techniques known to a skilled technician. In practice, a transparent paint or a printing ink (such as solvent-based printing inks for flexible packaging Gecko® Bond Star NP by Huber Group) comprising graphene GFN 6 is spread directly onto the face 1a. The applied layer is of 1 g/sqm to 5 g/sqm; preferably of 2 g/sqm to 4 g/sqm; still more preferably of 3 g/sqm (weight considered as dry residue). A layer applied to about 3 g/sqm corresponds to a thickness of about 2 microns. Preferably, graphene is present in an amount of 1% to 15% by weight, with respect to the weight of the paint or layer or coating; preferably in an amount of 3% to 12% by weight; still more preferably in an amount of 5 to 10% by weight.

A fourth embodiment of the multilayer material of the present invention is shown in FIG. 5 and comprises the multilayer material described above and shown in FIG. 2, in which a layer or coating of a material comprising or alternatively consisting of graphene GFN 6 (having a first outer face 6a and a second outer face 6b) is coupled or arranged with its end 6b onto said first outer face 1a of said material comprising or alternatively consisting of cellulose acetate AC 1. Said layer or coating of said material comprising or alternatively consisting of graphene GFN 6 is applied by means of a flexographic or gravure printing method by lamination, according to the equipment and techniques known to a skilled technician. In practice, a transparent paint or a printing ink (such as solvent-based printing inks for flexible packaging Gecko® Bond Star NP by Huber Group) comprising graphene GFN 6 is spread directly onto the face 1a. The applied layer is of 1 g/sqm to 5 g/sqm; preferably of 2 g/sqm to 4 g/sqm; still more preferably of 3 g/sqm (weight considered as dry residue). A layer applied to about 3 g/sqm corresponds to a thickness of about 2 microns. Preferably, graphene is present in an amount of 1% to 15% by weight, with respect to the weight of the paint or layer or coating; preferably in an amount of 3% to 12% by weight; still more preferably in an amount of 5 to 10% by weight.

Said layer or coating made of graphene GFN 6 is a material comprising or alternatively consisting of graphene in platelet form, e.g. of grade H. Graphene platelets are single nanoparticles made up of piles of graphene sheets in the form of platelets. Each grade consists of particles with a similar thickness and average surface. In grade H the particles have an average thickness of about 15 nanometers and a surface of about 50 to 80 m²/g. Grade H is available with average particle diameters of 5, 15 or 25 microns.

An example of grade H graphene in platelet form can have e.g. the following characteristics:

Characteristics of Bulk Powder:

Bulk density: 0.03-0.1 g/cc; Oxygen content<1%; Residual Acid Content<0.5 wt %. Table 11 shows further characteristics of a graphene in platelet form.

Another example of graphene in platelet form (Graphite Nanoplatelets Powder) can have e.g. the following characteristics:

Characteristics of Bulk Powder:

Color: black; Appearance: powder; Carbon content>98%; Average flake thickness: 14 nm (30 layers); Average particle (lateral) size: 20-50 μm; Bulk density: 0.042-0.020 g/cm³; Residual acid content<1%; Specific surface area: 60-80 g/m².

A fifth embodiment of the multilayer material of the present invention is shown in FIG. 4 and comprises the multilayer material described above and shown in FIG. 1. A two-component polyurethane adhesive material as described above, or having similar characteristics G, is applied onto the outer face 1a by lamination. Separately, a layer of PET 7 (having a first face 7a and a second outer face 7b) is prepared, onto whose face a layer or coating of a material comprising or alternatively consisting of graphene GFN 6 (having a first outer face 6a and a second outer face 6b) is applied or arranged with its end 6b on said second outer face 7b. Said layer or coating of said material comprising or alternatively consisting of graphene GFN 6 is applied onto the PET by means of a flexographic or gravure printing method by lamination, according to the equipment and techniques known to a skilled technician. In practice, a transparent paint or a printing ink (such as solvent-based printing inks for flexible packaging Gecko® Bond Star NP by Huber Group) comprising graphene GFN 6 is spread directly onto the face 7b. The applied layer is of 1 g/sqm to 5 g/sqm; preferably of 2 g/sqm to 4 g/sqm; still more preferably of 3 g/sqm (weight considered as dry residue). A layer applied to about 3 g/sqm corresponds to a thickness of about 2 microns. Preferably, graphene is present in an amount of 1% to 15% by weight, with respect to the weight of the paint or layer or coating; preferably in an amount of 3% to 12% by weight; still more preferably in an amount of 5 to 10% by weight.

Then the layer PET 7, spread with graphene GFN 6, is coupled by lamination with said outer face 1a onto which a two-component polyurethane adhesive material as described above or having similar characteristics (G) has been previously applied, so as to obtain the multilayer material represented in FIG. 4.

A sixth embodiment of the multilayer material of the present invention is shown in FIG. 6 and comprises the multilayer material described above and shown in FIG. 2. A two-component polyurethane adhesive material as described above, or having similar characteristics G, is applied onto the outer face 1a by lamination. Separately, a layer of PET 7 (having a first face 7a and a second outer face 7b) is prepared, onto whose face 7b a layer or coating of a material comprising or alternatively consisting of graphene GFN 6 (having a first outer face 6a and a second outer face 6b) is applied or arranged with its end 6b on said second outer face 7b. Said layer or coating of said material comprising or alternatively consisting of graphene GFN 6 is applied onto the PET by means of a flexographic or gravure printing method by lamination, according to the equipment and techniques known to a skilled technician. In practice, a transparent paint or a printing ink (such as solvent-based printing inks for flexible packaging Gecko® Bond Star NP by Huber Group) comprising graphene GFN 6 is spread directly onto the face 7b. The applied layer is of 1 g/sqm to 5 g/sqm; preferably of 2 g/sqm to 4 g/sqm; still more preferably of 3 g/sqm (weight considered as dry residue). A layer applied to about 3 g/sqm corresponds to a thickness of about 2 microns. Preferably, graphene is present in an amount of 1% to 15% by weight, with respect to the weight of the paint or layer or coating; preferably in an amount of 3% to 12% by weight; still more preferably in an amount of 5 to 10% by weight.

Then the layer PET 7, spread with graphene GFN 6, is coupled by lamination with said outer face 1a onto which a two-component polyurethane adhesive material as described above or having similar characteristics (G) has been previously applied, so as to obtain the multilayer material represented in FIG. 6.

An example of the multilayer material represented in FIG. 5 can be schematized as follows: PE 4 (thickness about 40 microns, weight about 35 g/sqm) PA 5 (thickness about 15 microns, weight about 21 g/sqm) Al 3 (thickness about 9 microns, weight about 24 g/sqm) Al 2 (thickness about 9 microns, weight about 24 g/sqm) AC 1 (thickness about 14 microns, weight about 17 g/sqm) GFN 6 (thickness about 2 microns, weight about 3 g/sqm).

An example of the multilayer material represented in FIG. 6 can be schematized as follows: PE 4 (thickness about 40 microns, weight about 35 g/sqm) PA 5 (thickness about 15 microns, weight about 21 g/sqm) Al 3 (thickness about 9 microns, weight about 24 g/sqm) Al 2 (thickness about 12 microns, weight about 24 g/sqm) AC 1 (thickness about 14 microns, weight about 17 g/sqm) GFN 6 (thickness about 2 microns, weight about 3 g/sqm) PET 7 (thickness about 12 microns, weight about 17 g/sqm).

The Applicant has tested four different types of multilayer materials (MM).

1. In a first step the following items have been prepared:

1.1) 50 envelopes of 50 g (internal reference IC_00128) using a traditional multilayer material MM1 (prior art) having the following composition from the outside to the inside:
a first outer layer of polyester material PET having an average thickness of 12 μm and an average weight of 16.80 g/m²,
an intermediate aluminum layer having an average thickness of 18 μm and an average weight of 48.60 g/m²,
a second outer layer (formulation side) of polyethylene material PE having an average thickness of 60 μm and an average weight of 55.20 g/m². Schematically, the multilayer material can be represented as follows: [PET-adhesive-Al-adhesive-PE], wherein the single layers of material are coupled with a thickness of 2 μm and using an adhesive known to skilled technicians in an amount of 2.00 g/m². The multilayer material has a total thickness of 94 μm and a total weight of 124.60 g/m² with a tolerance of ±6% (Giflex 1).

An example of polyethylene material PE is shown in Table 1.

Polyethylene terephthalate (PET) belongs to the family of polyesters and is a thermoplastic resin.

TABLE 1

| | | Unit of | Nominal | | |
|---|---|---|---|---|---|
| General Properties | | measure | Value | Tolerance± | Method |
| Density | | g/cm³ | 0.93 | 0.5% | Internal method 04 |
| Thickness | | μm | 40 | 10% | ASTM D 2103 |
| C.O.F. Dynamic Film/Film | | | 0.27 | 0.05 | ASTM D 1894 |
| Optical density* | | | — | 10% | Internal method 05 |
| Gloss 60° | | % | 8.5 | 10% | ASTM D 2457 |
| Elmendorf Test | MD | mN | Below 500 | 10% | ASTM D 1922 |
| Elmendorf Tear | TD | | Below 500 | | |
| Tensile strength | MD | MPa | 12.5 | 10% | ASTM D 882 |
| at yield | TD | | 11 | | |
| Tensile strength | MD | MPa | 23.5 | 10% | ASTM D 882 |
| at break | TD | | 20 | | |
| Elongation at | MD | % | 230 | 10% | ASTM D 882 |
| break | TD | | 460 | | |
| Perforation | Strength | N | 28 | 10% | Internal method 03 |
| | Elongation | cm | 2.1 | 10% | Internal method 03 |
| | Energy | MJ/m³ | 41 | 10% | Internal method 03 |

*The optical density value applies to white films only

The characteristics of the multilayer material MM1 and the barrier characteristics thereof are shown below in Table 2:

TABLE 2
CHARACTERISTICS OF THE LAMINATE

| | Unit | Method | Values | Tolerances | NOTES |
|---|---|---|---|---|---|
| Bonding | N/15 mm | | ≧10.0 | | |
| COF | | Giflex 2 | ≦0.25 | ±0.05 | |
| Layer adhesion | N/15 mm | | ≧2.25 | | |

BARRIER CHARACTERISTICS
Values detected by product specifications

| | Unit of | | | | |
|---|---|---|---|---|---|
| | measure | Method | Values | Tolerances | NOTES |
| O₂ | cc/m² 24 h | ASTM | ≦1 | | 23° C. - |
| (oxygen) | | D3985 | | | 100% RH |
| Water vapor | g/m² 24 h | ASTM | ≧1 | | 38° C. - |
| | | F1249 | | | 90% RH |

1.2) 50 envelopes of 50 g (internal reference IC_00339) using a multilayer material MM2 (prior art) having the following composition from the outside to the inside:
a first outer layer of polyester material PET (polyethylene terephthalate) having an average thickness of 12 μm and an average weight of 16.80 g/m²,
an aluminum multilayer (two layers coupled with one another) obtained by coupling together two aluminum layers each having an average thickness of 9 μm and an average weight of 24.30 g/m²,
a second outer layer (formulation side) of polyethylene material PE having an average thickness of 60 μm and a weight of 55.20 g/m². Schematically, the multilayer material can be represented as follows: [PET-adhesive-Al-adhesive-Al-adhesive-PE], wherein the single layers of material are coupled with a thickness of 2 μm and using an adhesive known to skilled technicians in an amount of 2.00 g/m². The multilayer material has a thickness of 96 μm and a total weight of 126.60 g/m² with a tolerance of ±6% (Giflex 1). The chemical and mechanical properties of the multilayer material MM2 are shown below in Table 3:

TABLE 3
CHEMICAL AND MECHANICAL PROPERTIES

| Gas permeability | Method | Unit | Value |
|---|---|---|---|
| O₂ (oxygen) | ASTM D3985 | cm³/m² 24 h atm | 0.1 |
| Water vapor | ASTM1249 | g/m² 24 h atm | 0.1 |

With reference to the multilayer materials MM1 and MM2 in 1.1 and 1.2, the polyester material has a density of 1.45 kg/dm³; the aluminum material has a density of 2.7 kg/dm³; the polyethylene material has a density of 0.92 kg/dm³ and the adhesive has a density of 1.25 kg/dm³.

2. In a second step, 50 envelopes corresponding to the multilayer material MM2 (prior art) are compared with 50 envelopes as follows.

2.1 A multilayer material MM3 [AC-adhesive-Al-adhesive-Al-adhesive-PE] according to the present invention (FIG. 1). The multilayer material MM3 according to the present invention comprises:
a first outer layer of polyester acetate material AC having an average thickness of 14 μm and an average weight of 18.34 g/m²,
an aluminum multilayer (two layers coupled with one another) obtained by coupling together two aluminum layers each having an average thickness of 9 μm and an average weight of 24.30 g/m²,
a second outer layer (formulation side) of polyethylene material PE having an average thickness of 40 μm and an average weight of 35 g/m².

Schematically, the multilayer material MM3 according to the present invention can be represented as follows: [Ac-adhesive-Al-adhesive-Al-adhesive-PE], wherein the single layers of material are coupled with a thickness of 2 μm and using an adhesive known to skilled technicians in an amount of 2.00 g/m². The multilayer material has a thickness of 87 μm and a total weight of 101.34 g/m² with a tolerance of ±6% (Giflex 1).

2.2 A multilayer material MM4 [AC-adhesive-Al-adhesive-Al-adhesive-PA-PE] according to the present invention (FIG. 2). The multilayer material MM4 according to the present invention comprises:
a first outer layer of cellulose acetate material AC having an average thickness of 14 μm and an average weight of 18.34 g/m²,
an aluminum multilayer (two layers coupled with one another) obtained by coupling together two aluminum layers each having an average thickness of 9 μm and an average weight of 24.30 g/m²,
a layer of polyamide material PA having an average thickness of 15 μm and an average weight of 21 g/m²,
a second outer layer (formulation side) of polyethylene material PE having an average thickness of 40 μm and an average weight of 35 g/m².

Schematically, the multilayer material MM4 according to the present invention can be represented as follows: [Ac-adhesive-Al-adhesive-Al-adhesive-PA-adhesive-PE], wherein the single layers of material are coupled with a thickness of 2 μm and using an adhesive known to skilled technicians in an amount of 2.00 g/m². The multilayer material has a total thickness of 117 μm and a total weight of 122.34 g/m² with a tolerance of ±6% (Giflex 1).

With reference to the multilayer materials MM3 and MM4 in 2.1 and 2.2, the cellulose acetate material (AC) (ACE GLOSS, ref. CGT014, certified according to standard EN13432 and ASTM D 6400) used by way of example has a thickness of 14 μm, a unit weight of 18.34 g/m², coefficient of friction (COF) ASTM D 1894 of 0.15-0.30, surface tension ASTM of 34-38 dyne/cm, breaking load ASTM D 882 of 80-100 Nmm⁻², elongation at break ASTM D 882 25-35%, tensile modulus ASTM D 882 of 2300-2800 Nmm⁻², tear initiation ASTM D 1938 0.010 N, tear propagation ASTM D 1938 0.006 N. The properties are shown in Table 4.

TABLE 4

| | | METHOD | UNIT OF | |
|---|---|---|---|---|
| THERMAL PROPERTIES | | USED | MEASURE | VALUE |
| Linear shrinkage | MD | Internal | % | — |
| (115° C., 10 min) | | | | |
| Dimensional stability | MD | Internal | % | 2.15 |
| (20 hours, 80° C., | | | | |
| 95% RH) | | | | |

| | | | |
|---|---|---|---|
| Softening temperature | Internal | ° C. | About 130 |
| Glass transition temperature | Internal | ° C. | About 120 |

An example of a hygroscopic polyamide material PA is shown below in Table 5.

TABLE 5

| | | | | |
|---|---|---|---|---|
| Properties | Units | Nominal | Method | Conditions |

Mechanical Properties

| Nominal thickness | | μ | 15.0 | Kolon Method |
|---|---|---|---|---|
| Unit weight | | g/m² | 17.4 | |
| Density | | kg/dm³ | 1.16 | ASTM D-792 |
| Yield | | m²/kg | 57.4 | |
| Elongation at | MD | % | 140 | ASTM D-882 |
| break | TD | % | 130 | |
| Tensile strength | MD | kg/cm² | 28 | ASTM D-882 |
| | TD | kg/cm² | 29 | |

Thermal properties

| | | | | | |
|---|---|---|---|---|---|
| Heat shrinkage | MD | % | 3.0 | Kolon Method | 100° C., |
| (by hot water) | TD | % | 3.0 | | 30 minutes |

Surface Properties

| | | | |
|---|---|---|---|
| Coefficient of fricton | μs | 0.55 | ASTM D-1894 |
| Coefficient of fricton | μk | 0.55 | ASTM D-1894 |
| Wetting tension | dyne/cm | 54 | ASTM D-2578 |

Optical Properties

| | | | |
|---|---|---|---|
| Haze | % | max. 4.0 | ASTM D-1003 |

STANDARD ROLL PRESENTATION

| Thickness μ | Core mm | Length mm | Outside diameter mm |
|---|---|---|---|
| 15 | 152 | 12000 | 530 |

An example of a polyester material PET (polyethylene terephthalate) as used here is shown below in Table 6.

TABLE 6

| | | | | |
|---|---|---|---|---|
| Properties | Units | Nominal | Method | Conditions |

Mechanical Properties

| Nominal thickness | | μ | 12 | PTL Method |
|---|---|---|---|---|
| Tensile strength | MD | kg/cm³ | 2200 | ASTM D-882 |
| | TD | kg/cm³ | 2300 | |
| Elongation at | MD | % | 125 | ASTM D-882 |
| break | TD | % | 120 | |

Thermal properties

| | | | | | |
|---|---|---|---|---|---|
| Heat shrinkage | MD | % | 2.0 | ASTM D-1204 | 150° C./ |
| | TD | % | 0.0 | | 30 minutes |

Surface Properties

| | | | |
|---|---|---|---|
| Surface tension: | dyne/cm | 56 | ASTM D-2578 |
| chemically treated side | | | |
| Surface tension: corona | dyne/cm | 52 | ASTM D-2578 |
| treated side | | | |
| Coefficient of static | | 0.48 | ASTM D-1894 |
| friction | | | |
| Coefficient of dynamic | | 0.44 | ASTM D-1894 |
| friction | | | |

Physical/Chemical Properties

| | | | |
|---|---|---|---|
| Light transmission | % | 90 | ASTM D-1003 |
| Density | g/cm³ | 1.4 | |

Optical Properties

| | | |
|---|---|---|
| Haze | % | 2.5 |

Barrier Properties

| | | | | |
|---|---|---|---|---|
| O2 Permeability | cc/m² · Day | 130 | ASTM D 3985-95 | 37.7° C. |
| | | | | 0 %RH |
| WVTR | g/m² · Day | 40 | ISO 15106-1:03 | 23° C. |
| | | | | 90% RH |

Yield properties

| | | | |
|---|---|---|---|
| Yield | m²/kg | 59.7 | Polyplex Method |

STANDARD ROLL PRESENTATION

| Thickness μ | Core mm | Length mm | Outside diameter mm |
|---|---|---|---|
| 12 | 76 | 12000 | 450 |
| 12 | 152 | 18000 | 570 |
| 12 | 152 | 24000 | 650 |

An example of a polyester material PET (polyethylene terephthalate) as used here is shown below in Table 7.

TABLE 7

| | | | | |
|---|---|---|---|---|
| Property | Units | Nominal | Method | Conditions |

Mechanical Properties

| Nominal thickness | | μ | 12 | PTL Method |
|---|---|---|---|---|
| Yield | | m²/kg | 59.6 | Polyplex Method |
| Unit weight | | g/m² | 16.80 | |
| Density | | g/m³ | 1.4 | |
| Elongation at | MT | % | 130 | ASTM D-882 |
| break | DT | % | 125 | |
| Tensile strength | MT | kg/cm² | 2200 | ASTM D-882 |
| | DT | kg/cm² | 2300 | |

Thermal Properties

| | | | | | |
|---|---|---|---|---|---|
| Heat Shrinkage | MT | % | 2.0 | ASTM D-1204 | 150° C./ |
| | DT | % | 0.2 | | 30 minutes |

Surface Properties

| | | | |
|---|---|---|---|
| Coefficient of static | | 0.52 | ASTM D-1894 |
| friction A-B | | | |
| Coefficient of | | 0.40 | ASTM D-1894 |
| dynamic friction A-B | | | |
| Surface tension | dyne/cm | 52 | ASTM D-2578 |
| (corona treated side) | | | |

Optical Properties

| | | | |
|---|---|---|---|
| Haze | % | 2.3 | ASTM D-1003 |
| Light Transmission | % | 88 | ASTM D-1003 |

Barrier Properties

| | | | | |
|---|---|---|---|---|
| WVTR | g/m² · Day | 40 | ISO 15106-1:03 | 23° C. |
| | | | | 90%RH |
| O2 Permeability | cm³/m² · Day | 130 | ASTM D-3985-95 | 23° C. |
| | | | | 0% RH |

STANDARD ROLL PRESENTATION

| Thickness μ | Core mm | Length m | Outside diameter mm |
|---|---|---|---|
| 12 | 76 | 6000 | 325 |
| 12 | 76 | 12000 | 450 |
| 12 | 152 | 18000 | 570 |
| 12 | 152 | 24000 | 650 |
| 12 | 152 | 36000 | 785 |

With reference to the multilayer materials MM3 and MM4 in 2.1 and 2.2, the polyethylene material PE has the properties shown in Table 1.

With reference to the multilayer materials MM3 and MM4 in 2.1 and 2.2, the adhesive referred to as G in FIGS. 1 and 2 is e.g. a two-component, solvent-based polyurethane adhesive of the type NOVACOTE NC-250-A with catalyst CA-350—COIM DEUTSCHLAND GmbH. The solvents that can be used are ethyl acetate of urethane grade or acetone (water content below 0.1%). The properties are shown in Table 8 A and B.

TABLE 8A

| | NC-250-A | CA-350 |
|---|---|---|
| Nature | NCO | OH |
| Solid content [%] | 60 ± 1 | na |
| Viscosity at 25° C. | 400 ± 150 (mPas) | 21 ± 3 DIN 4 mm |
| Solvent | ethyl acetate | — |
| Density at 20° C. [g/cm³] | 1.07 | 1.00 |
| Appearance | transparent | transparent |
| Mixing ratio [weight] | 100 | 5 |

TABLE 8B

Solid content [%]

| | 30% | 35% | 40% | 45% |
|---|---|---|---|---|
| NC-250-A [kg] | 100 | 100 | 100 | 100 |
| Ethyl acetate [kg] | 100 | 72 | 50 | 34 |
| CA-350 [kg] | 5 | 5 | 5 | 5 |
| Viscosity DIN-4 Cup | 12 | 13 | 15 | 19 |
| at 25° C. [sec.] | | | | |

The aim of the comparison tests between the four types of multilayer materials MM1, MM2 and MM3, MM4 is to evaluate the best type in terms of isolation and protection of the product from external moisture. This improvement also affects the stability of the viable bacterial cells of the product and thus the storage time at room temperature (T≦25° C.)

In the first step of the assay, for each type of multilayer material MM1 (traditional material) and MM2, 50 envelopes of 50 g have been prepared, each containing a freeze-dried formulation of Lactobacillus rhamnosus GG and Lactobacillus acidophilus LA02 in a weight ratio of 1:1. The envelopes have been stored at room temperature (T≦25° C.). The parameter “Free water Aw” of the product has been evaluated every three months. The data are shown in Table 9.

TABLE 9

| | | | Zero | 3rd | 6th |
|---|---|---|---|---|---|
| | | Multilayer | time | month | month |
| Formulation | Batch | material | Aw | Aw | Aw |
| Lactobacillus | FL020-13 | MM1 | 0.055 | 0.085 | 0.120 |
| rhamnosus | | Traditional | | | |
| GG | | MM2 | 0.055 | 0.060 | 0.066 |
| Lactobacillus | FL003-14 | MM1 | 0.030 | 0.070 | 0.100 |
| acidophilus | | Traditional | | | |
| LA02 | | MM2 | | | |
| | | | 0.030 | 0.035 | 0.042 |

In the second step of the assay, 50 sachets containing dried FOS (fructooligosaccharides) (FL 007-14), have been prepared using the multilayer material referred to as MM2 e MM3. Dried FOS (or also dried maltodextrin) has been chosen as reference for simulating the most extreme conditions under which the free water Aw test has to be performed. The reason is that FOS can be dried to very low free water values, below 0.03, which is hard to obtain in the case of dried or freeze-dried bacteria. The sachets have been stored at room temperature (T≦25° C.). The parameter “Free water Aw” of the product FOS (free water Aw: part of water molecules not bound to sugars, amides, pectins, proteins, thus immediately available for microbial metabolism, a parameter strictly related to the properties of a food product) is evaluated first on a weekly basis and then every month.

Equipment: Water activity meter AQUALAB series 3TE_Decagon.

The data are shown in Table 10.

TABLE 10

| | | Multilayer | Zero time | 1st week |
|---|---|---|---|---|
| Formulation | Batch | material | Aw | Aw |
| Dried FOS or dried | FL007-14 | MM2 | <0.029 | 0.030 |
| maltodextrins | | MM3 | <0.029 | <0.029 |
| | | Multilayer | 2nd week | 3rd week |
| Formulation | Batch | material | Aw | Aw |
| Dried FOS or dried | FL007-14 | MM2 | 0.030 | 0.032 |
| maltodextrins | | MM3 | <0.029 | <0.029 |
| | | Multilayer | 1st month | 2nd month |
| Formulation | Batch | material | Aw | Aw |
| Dried FOS or dried | FL007-14 | MM2 | 0.032 | 0.038 |
| maltodextrins | | MM3 | <0.029 | <0.029 |
| | | Multilayer | 3rd month | 6th month |
| Formulation | Batch | material | Aw | Aw |
| Dried FOS or dried | FL007-14 | MM2 | 0.040 | 0.042 |
| maltodextrins | | MM3 | <0.029 | <0.029 |
| | | Multilayer | 12th month | 18th month |
| Formulation | Batch | material | Aw | Aw |
| Dried FOS or dried | FL007-14 | MM2 | 0.045 | 0.048 |
| maltodextrins | | MM3 | <0.029 | <0.029 |
| | | Multilayer | 24th month | |
| Formulation | Batch | material | Aw | |
| Dried FOS or dried | FL007-14 | MM2 | 0.050 | |
| maltodextrins | | MM3 | <0.029 | |

Similar results in terms of stability at T≦25° C. have been obtained by the Applicant also with the multilayer materials according to the present invention, represented by embodiments as those shown in FIGS. 3, 4, 5 and 6,

TABLE 11

| | Typical Value - | Typical Value - | |
|---|---|---|---|
| | Parallel to | Perpendicular | Unit of |
| Property | surface | to surface | measure |
| Density | 2.2 | 2.2 | grams/cc |
| Carbon Content | >99.5 | >99.5 | percent |
| Thermal Conductivity | 3,000 | 6 | watts/meter-K |
| Thermal Expansion | 4 − | 0.5 − | m/m/deg.-K |
| (CTE) | 6 × 10⁻⁶ | 1.0 × 10⁻⁶ | |
| Tensile Modulus | 1,000 | na | GPa |
| Tensile strength | 5 | na | GPa |
| Electrical Conductivity | 10⁷ | 10² | siemens/meter |

1. A fully moisture-tight multilayer material, which is able to absorb, retain and not release the absorbed moisture or free water into the formulations containing pharmacological active substances and/or instable and/or easily perishable components with biological activity, said multilayer material comprising.
a first outer layer of a material comprising or alternatively consisting of cellulose acetate AC 1 having a first outer face 1a and a second outer face 1b;
at least a first layer of a material comprising or alternatively consisting of aluminum Al 2 and a second layer of a material comprising or alternatively consisting of aluminum Al 3, coupled with one another so as to obtain an aluminum multilayer 2-3 having a first outer face 2a and a second outer face 3b;
a second outer layer of a material comprising or alternatively consisting of polyethylene PE 4 having a first outer face 4a and a second outer face 4b;
wherein said second outer face 1b is coupled with said first outer face 2a and said second outer face 3b is coupled with said first outer face 4a, and wherein said first outer face 1a is in contact with one or more raw materials or with a formulation containing pharmacological active substance and/or instable and/or easily perishable components with biological activity.

2. The multilayer packaging material according to claim 1, wherein a layer of hygroscopic material 5, having a first outer face 5a and a second outer face 5b, is introduced by coupling between said aluminum multilayer 2-3, having a first outer face 2a and a second outer face 3b, and said layer of polyethylene material, having a first outer face 4a and a second outer face 4b, wherein the coupling is made between said second outer face 3b with said first outer face 5a and between said outer face 5b and said inner face 4a.

3. The material according to claim 1, wherein a layer or coating of a material comprising or alternatively consisting of graphene GFN 6, having a first outer face 6a and a second outer face 6b, is coupled or arranged with its end 6b onto said first outer face 1a of said material comprising or alternatively consisting of cellulose acetate AC 1.

4. The material according to claim 1, wherein said first outer face 1a is coupled with a layer of PET 7, having a first outer face 7a and a second outer face 7b, onto whose face 7b a layer or coating of a material comprising or alternatively consisting of graphene GFN 6, having a first outer face 6a and a second outer face 6b, is applied or arranged with its end 6a on said second outer face 7b.

5. The material according to claim 2, wherein said first outer face 1a is coupled with a layer of PET 7, having a first face 7a and a second outer face 7b, onto whose face 7b a layer or coating of a material comprising or alternatively consisting of graphene GFN 6, having a first outer face 6a and a second outer face 6b, is applied or arranged with its end 6a on said second outer face 7b.

6. The material according to claim 1, wherein the layer of cellulose acetate material 1 has an average thickness of 5 to 50 microns, preferably of 10 to 30 microns, still more preferably of 15 to 20 microns.

7. The material according to claim 6, wherein said cellulose acetate material is selected among those having a thickness of 13 μm and a unit weight of about 18.34 g/m².

8. The material according to claim 1, wherein the layer of cellulose acetate material 1 is made up of one to more single layers, preferably of 2 to 4 layers.

9. The material according to claim 1, wherein said aluminum multilayer 2-3 comprises at least two aluminum layers 2 and 3, each single layer having a thickness of 5 to 40 microns, preferably of 8 to 20 microns.

10. The material according to claim 2, wherein said layer of hygroscopic material 5 has an average thickness of 5 to 1000 microns, preferably of 10 to 50 microns; still more preferably it has a thickness of 15 microns and a weight of about 21 g/sqm.

11. The material according to claim 10, wherein the hygroscopic material 5 comprises or alternatively consists of a polyamide or nylon 6, preferably said hygroscopic material being made up of one to more single layers such as e.g. 2 to 4 layers.

12. Use of a multilayer material according to claim 1 for preparing a container in the form of a bag, envelope, sachet and stick for packaging a formulation containing pharmacological active substances and/or instable and/or easily perishable components with biological activity and/or effervescent formulations.

13. The use according to claim 12, wherein the formulation comprises lactic bacteria or probiotic bifidobacteria in powder or granules, either dried or freeze-dried.
